(19) United States
(12) Patent Application Publication
(10) Pub. No.: US 2008/0096010 A1
(43) Pub. Date: Apr. 24, 2008

(54) Rear Surface Mirror

(76) Inventors: Michael Scheler, Jena (DE); Wieland Stockl, Jena (DE); Hein Uhlig, Jena (DE); Norbert Kaiser, Jena (DE)

Correspondence Address: Andrew R Basile;3001 West Big Beaver, Suite 624, Troy, MI, 48084, US

(21) Appl. No.: 11/632,444

(22) PCT Filed: May 17, 2005
(86) PCT No.: PCT/EP05/05350

§ 371 Date: Oct. 10, 2007

(30) Foreign Application Priority Data
Jul. 16, 2004 (DE) 10 2004 034369. 1

(51) Int. Cl. B32B 17/06

(52) U.S. Cl. 428/332; 428/432

(57) ABSTRACT

The invention relates to a rear surface mirror having a substrate which is transparent for the light to be reflected and having a silver layer which is applied on its rear side, a first intermediate layer being introduced as underlayer between the substrate and the silver layer at least in regions, said underlayer comprising a high-melting oxide or containing the latter and having a higher melting point than silver, and a further cover layer being applied on the side of the silver layer, which is orientated away from the substrate, at least in regions, said cover layer comprising one of the high-melting metals ruthenium, iridium, osmium, palladium, platinum, rhenium and/or rhodium or containing these.

### BACKGROUND

The present invention relates to a rear surface mirror, in particular a temperature-resistant silver-containing rear surface mirror. Mirrors of this type are used in particular as a coating for panes of glass before thermal shaping/machining or for example as reflectors in lamps.

Of all metals, silver has the highest reflection for visible light. Rear surface reflectors for the visible spectral range therefore frequently comprise a glass substrate which is coated on one side with silver. In the case of the rear surface reflector, the light to be reflected enters through the uncoated or anti-reflection front surface into the glass substrate, penetrates the glass substrate and is reflected on the silver-coated substrate rear face.

The optical power (reflection) of a silver rear surface reflector is in a very favourable ratio to its comparatively low manufacturing outlay.

The low climatic and mechanical stability of silver layers have a restrictive effect.

In particular in a damp, oxygen- and hydrogen sulphide-containing atmosphere, unprotected silver layers are not climate-resistant but corrode and become dark-coloured. A very extensive protection of the silver layer relative to climatic effects is state of the art with silver rear surface mirrors: on the light inlet side, the glass substrate protects the silver layer from climatic effects and the air-side boundary surface of the silver layer can be sealed with cover layers, cover paints or adhesive cover panes of glass without consideration of optical requirements.

The mechanical instability of silver layers resides, on the one hand, in their low hardness and scratch-resistance and, on the other hand, in their weak adhesion to glass. The above-mentioned sealing measures frequently are effective not only as climatic protection but also as scratch protection for the silver reflector layer. If the adhesion of the silver layer on the substrate is to be improved, the substrate surface is covered with an adhesion-promoting intermediate layer before application of the silver layer. Since this intermediate layer is situated on the light incidence side of the reflector, the choice of material and thickness of this layer is however restricted by the requirement that the intermediate layer must not substantially reduce the reflection.

Manufacturing costs, reflection and resistance to ageing of conventionally constructed rear surface mirrors on a silver base are satisfactory as long as these mirrors are not subjected to too high temperatures

Conventional rear surface mirrors on a silver base fail if they are subjected constantly to high temperatures.

With increasing temperature, diffusion processes are activated in silver layers, said diffusion processes transporting silver such that the particle sizes increase, holes and cracks are produced and grow in the layer so that an increasing part of the substrate surface is no longer covered with silver until finally the silver collects together in mutually isolated islands (agglomeration) and no longer coherently covers the substrate surface. Ultimately the silver layer loses its high reflection because of the agglomeration. These transport processes accelerate with increasing temperature and, above 600° C., the agglomeration of single silver layers is effected within a few hours.

A further limitation for the temperature stability of silver layers arises by the evaporation thereof. A layer removal at 20 nm/hour is calculated in a vacuum at 650° C. from the known evaporation pressure of silver. In fact the evaporation rate in atmosphere is significantly reduced by being scattered back, at high temperatures however the increasing silver evaporation might contribute substantially to the material transport.

Measures which improve the resistance of silver layers to high temperatures up to approx. 600° C. are described in the literature. Admixtures are described for the silver layers and also underlayers or cover layers.

It is plausible that admixtures can impede the silver diffusion and that temperature-stable underlayers and cover layers with good adhesion to the silver stabilise the covering of the boundary surfaces. With some of the described measures, silver-based reflector layers were made thermally so stable that they were able to be subjected to temperatures up to approx. 700° C. with an effective duration of minutes up to a few hours (for instance in order to shape the glass substrate).

Temperatures significantly above 700° C. require the replacement of silver by more temperature-resistant reflector metals which however reflect less strongly.

In the case of a reflector which operated for more than 2000 hours above 1000° C., a metallic reflector layer was entirely dispensed with and the reflection was produced by a dielectric interference system comprising high-melting oxides, which is substantially more expensive relative to a metallic reflector layer system.

### SUMMARY

It is the object of the present invention to make available a rear surface mirror which, on the one hand, is based on a high-reflection and economical silver-based reflector layer system but, on the other hand, is very temperature-resistant and can be subjected for example over more than 2000 hours to temperatures above 600° C. without impairment to its function.

This object is achieved by the rear surface mirror according to a first intermediate layer introduced as an underlayer between the substrate and the silver layer at least in regions, said underlayer comprising a high melting oxide or continuing the latter and having a higher melting point than silver and a further cover layer is applied on the side of the silver layer which is orientated away from the substrate, at least in regions said cover layer comprising one of the high-melting metal ruthenium, iridium, osmium, palladium, platinum, rhenium and/or rhodium or containing these. Advantageous developments of the rear surface mirror according to the invention are given hereinafter. Uses for rear surface mirrors of this type included on panes of glass for thermal shaping or machining or as a reflector of a lamp.

According to the invention, a rear surface mirror is produced in such a manner that a silver layer is applied on a substrate which is transparent for the light to be reflected, for example glass or quartz glass, on the rear side. However an underlayer is inserted between the substrate and the silver layer, said underlayer comprising a high-melting oxide or containing the latter and having a higher melting point than the silver of the silver layer. On the side of the silver layer which is orientated away from the substrate, a cover layer is applied which comprises a high-melting metal, in particular ruthenium, iridium, osmium, palladium, platinum, rhenium and/or rhodium or contains these. A combination of an underlayer made of zirconium oxide and a cover layer made of ruthenium is particularly advantageous. With a high-refraction dielectric layer of this type such as zirconium oxide, an increase in reflection in selected spectral ranges is even possible due to constructive interference, whilst, with metallic underlayers, merely a very low thickness would be permissible in order not to drastically reduce the reflection of the rear surface mirror.

Zirconium dioxide has a melting temperature of 2700° C. and ruthenium a melting temperature of 2300° C. so that the melting temperature of the underlayer and of the cover layer is higher than the melting temperature of the silver.

Advantageously, a thin adhesion-promoting tungsten layer with a melting temperature of 3400° C. can be inserted between the silver layer and the cover layer.

The ruthenium used preferably for the cover layer is extremely stable chemically and has the greatest hardness amongst the noble metals. It is therefore particularly suitable for use as cover layer.

The layer system is consequently constructed such that the silver layer with a melting temperature of 961° C. is intercalated between two substantially higher-melting layers which show no diffusion effects at 600° C. and hence stabilise the silver layer.

The layer construction according to the invention has the high reflection and the low manufacturing costs of silver-based reflector systems but, relative to conventional silver-based reflector systems, is characterised by exceptionally high temperature stability. Compared with other silver-based systems, there was produced, in comparative tests with a completely undestroyed silver layer, generally at least twice the service life.

In the following, an example of a rear surface mirror according to the invention is now described.

### BRIEF DESCRIPTION OF THE DRAWINGS

The single FIGURE shows the layer structure of a rear surface mirror, as was used for quartz glass bulbs of halogen lamps with a power of 50 W.

### DESCRIPTION

A quartz glass bulb was used as substrate 2, onto which a zirconium dioxide underlayer 4 with a thickness of 10 nm was applied. Onto this zirconium dioxide underlayer 4, a silver layer 3 with a thickness of 600 nm was applied. This follows an adhesion-promoting tungsten layer 5 with a thickness of 65 nm and a ruthenium layer 6 with a thickness of 500 nm. All the layers were applied by vacuum coating (sputtering or ion-assisted evaporation).

The incident light 1a now penetrates the quartz glass bulb 2 and the zirconium dioxide underlayer 4 and is reflected on the surface of the silver layer 3 as reflected light 1.

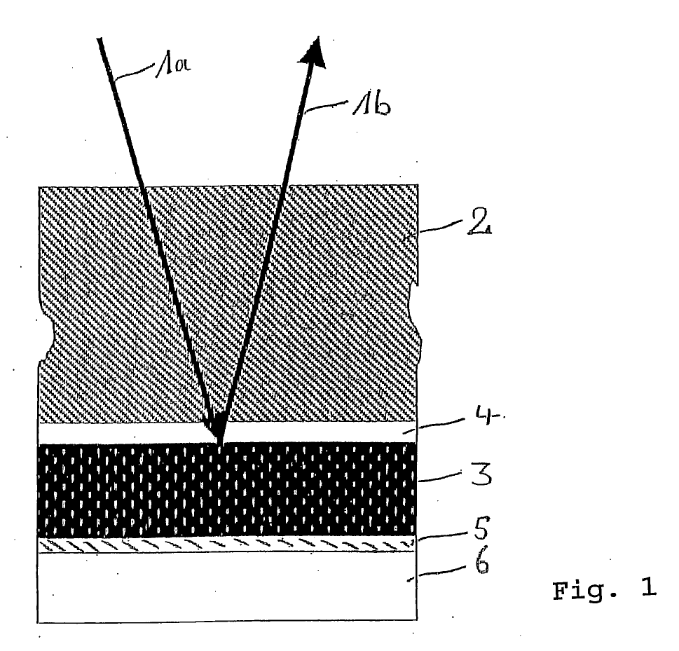

During operation, the bulb of the halogen lamp is heated to above 600° C. The reflection of the rear surface mirror deposited thereon according to FIG. 1 was maintained without measurable impairment over an operating duration of more than 2000 hours.

1. Halogen lamp having a quartz glass bulb as substrate which is transparent for the light to be reflected and having a rear surface mirror which is applied on the quartz glass bulb and has a silver layer,
characterised in that
a first intermediate layer is introduced as underlayer between the substrate and the silver layer at least in regions, said underlayer comprising a high-melting oxide or containing the latter and having a higher melting point than silver,
and a further cover layer is applied on the side of the silver layer, which is orientated away from the substrate, at least in regions, said cover layer comprising one of the high-melting metals ruthenium, iridium, osmium, palladium, platinum, rhenium and/or rhodium or containing these.

2. Halogen lamp according to one of the preceding claims, characterised in that the material of the first intermediate layer is or contains zirconium dioxide, hafnium oxide, yttrium oxide, aluminium oxide, titanium oxide, tantalum oxide, niobium oxide, cerium oxide, magnesium oxide and/or zinc oxide.

3. Halogen lamp according to one of the preceding claims, characterised in that the material of the first intermediate layer is or contains a dielectric material.

4. Halogen lamp according to one of the preceding claims, characterised in that the first intermediate layer has a thickness between 1 nm and 100 nm, preferably between 5 nm and 20 nm, preferably of 10 nm.

5. Halogen lamp according to one of the preceding claims, characterised in that the cover layer has a thickness between 1 nm and 2000 nm, preferably between 100 nm and 1000 nm, preferably of 500 nm.

6. Halogen lamp according to one of the preceding claims, characterised in that the material of the first intermediate layer is or contains zirconium dioxide and the material of the cover layer is or contains ruthenium.

7. Halogen lamp according to one of the preceding claims, characterised in that the silver layer has a thickness between 1 nm and 2000 nm, preferably between 100 nm and 1000 nm, preferably of 600 nm.

8. Halogen lamp according to one of the preceding claims, characterised in that an adhesion-promoting layer is disposed between the silver layer and the cover layer.

9. Halogen lamp according to the preceding claim, characterised in that the adhesion-promoting layer comprises tungsten or contains the latter.

10. Halogen lamp according to one of the two preceding claims, characterised in that the adhesion-promoting layer has a thickness between 1 nm and 200 nm, preferably between 10 nm and 100 nm, preferably of 65 nm.
